(19) United States
(12) Patent Application Publication
(10) Pub. No.: US 2026/0330057 A1
(43) Pub. Date: Oct. 22, 2026

(54) DEFLECTION LOGIC FOR FINE-TUNING LANGUAGE MODELS

(71) Applicant: MASTERCARD INTERNATIONAL INCORPORATED, Purchase, NY (US)

(72) Inventors: Ruizhi Wang, Dublin (IR); Arjun Dussa, Dublin (IR); Xi Jin, Kilgobbin (IR); Stephen Elder, Co. Dublin (IR); Jose Pereira, Dublin (IR); Jessica Greco, Dobbs Ferry, NY (US)

(73) Assignee: MASTERCARD INTERNATIONAL INCORPORATED, Purchase, NY (US)

(21) Appl. No.: 19/654,078

(22) Filed: Apr. 21, 2026

Related U.S. Application Data
(60) Provisional application No. 63/792,748, filed on Apr. 22, 2025.

(51) Int. Cl. G06F 21/62; G06F 16/9035

(52) U.S. Cl. CPC G06F 21/6227; G06F 16/9035

(57) ABSTRACT

A system may access a plurality of questions from one or more users. The system may, for each question, from among the plurality of questions, execute deflection logic comprising: trusted user deflection that determines whether or not a user that posed the question is a trusted user, relevance deflection that determines whether or not the question is relevant to an information domain from among the plurality of information domains, gold Question and Answer (QnA) pair deflection that determines whether or not the question matches a question from a curated set of gold QnA pairs, and/or uniqueness deflection that determines whether or not the question was previously asked and answered. The system may filter questions for Human-In-The-Loop (HITL) review based on the deflection logic. The system may then fine-tune a large language model based on the filtered questions and their respective answers.

### CROSS-REFERENCE TO RELATED APPLICATIONS

This application claims priority to U.S. Provisional Patent Application No. 63/792,748, filed Apr. 22, 2025, which is incorporated by reference in its entirety herein.

### BACKGROUND

Language models such as Large Language Models (LLMs) may be pretrained on a large corpus of text. Language models can generate text, such as responses to questions, by learning general language patterns, sentence structures, semantic meanings, and knowledge from the large corpus. However, the corpus of text is general in nature and may not adequately cover specialized domain knowledge. For tasks that require expert-level understanding or domain-specific terminology, fine-tuning these models is often necessary to improve their performance. For example, fine-tuning may use domain-specific data that are reviewed by Subject Matter Experts (SMEs) in the domains of interest.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment for fine-tuning a QnA response system with Retrieval-Augmented Generation (RAG) using Large Language Models (LLMs);

FIG. 2 illustrates an example of a method of deflection logic for Human-In-The-Loop curation of QnA pairs for fine-tuning LLMs;

FIG. 3 illustrates an example of a data flow of deflection logic for HITL curation of QnA pairs for fine-tuning language models;

FIG. 4 illustrates an example of a data flow of fine-tuning a language model based on annotated QnA pairs;

FIG. 5 illustrates an example of a method of deflection for generating QnA pairs for fine tuning a language model; and

FIG. 6 illustrates an example of a computer system that may be implemented by devices illustrated in FIG. 1.

### DETAILED DESCRIPTION

The disclosure relates to deflection logic for curating datasets used to fine-tune language models. Fine-tuning language models may require large amounts of domain-specific data that is reviewed by SMEs during Human In The Loop (HITL) review. Oftentimes, HITL review is important for risk control in generative AI applications, such as by ensuring that accurate data is used for training (fine-tuning), sensitive information such as Personally Identifying Information (PII) is not exposed to models and the answers they provide, and other considerations. However, because of the scale of domain-specific data that may be available for HITL review, SMEs typically review large amounts of data, much of which is not included in fine-tuning datasets. This can result in reduced or insufficient annotated data for fine-tuning.

One example of HITL review for fine-tuning may be included in a system that facilitates generative AI interactions between an LLM and a human user that asks questions. For example, a human user may engage in a chat session (or other communication session) in which the human user asks questions and the LLM provides answers to those questions. A question and an answer may be referred to as a Question-and-Answer (QnA) pair. A given chat session may include multiple QnA pairs. During HITL review, a SME may review QnA pairs and determine whether the LLM's answer was acceptable. If so, the SME may approve the QnA pair. If not, the SME may disapprove the QnA pair. Approved QnA pairs may be selected for fine-tuning the LLM and benchmark efficacy scoring. In some instances, the SME may modify an answer in a QnA pair. In this case, because the SME is a trusted user, the modified answer, along with the original question in the QnA pair, may be selected for fine-tuning the LLM and benchmark efficacy scoring.

To address these and other issues with fine-tuning language models for QnA and other tasks, a system execute deflection logic that evaluates candidate fine-tuning data, such as questions and/or QnA pairs, and filters the data for HITL review. Thus, SMEs may be presented with fewer fine-tuning data for review. This in turn may increase the available fine-tuning data. Once the fine-tuning data is curated, the system may fine-tune a language model to generate answers to questions or perform other tasks. The system may also improve the way in which answers are evaluated that takes into account quality of the answer, in addition to technical merits of the answer.

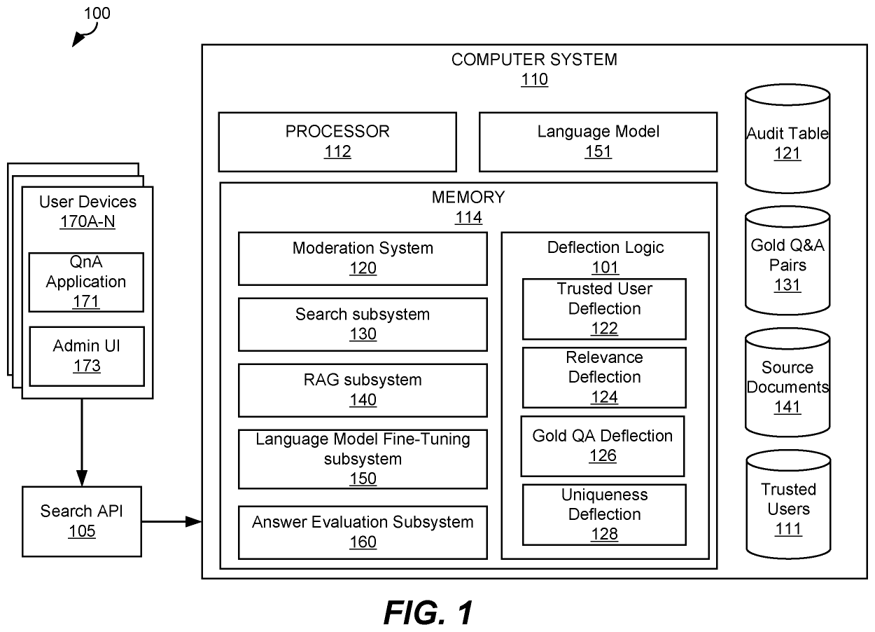

FIG. 1 illustrates an example of a system environment 100 for fine-tuning a QnA response system with Retrieval-Augmented Generation (RAG) using Large Language Models (LLMs). The system environment 100 may include a computer system 110, an audit table 121, a gold QnA pairs datastore 131, a source documents datastore 141, a language model 151, one or more user device 170A-N, and/or other components. At least some of the components of the system environment 100 may be connected to one another via a communication network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

The trusted user datastore 111 is a datastore that stores user identities in association with their corresponding user roles. A user role may define a trusted status of the user. For example, a user role may indicate that a user is a subject matter expert (SME) in one or more domains.

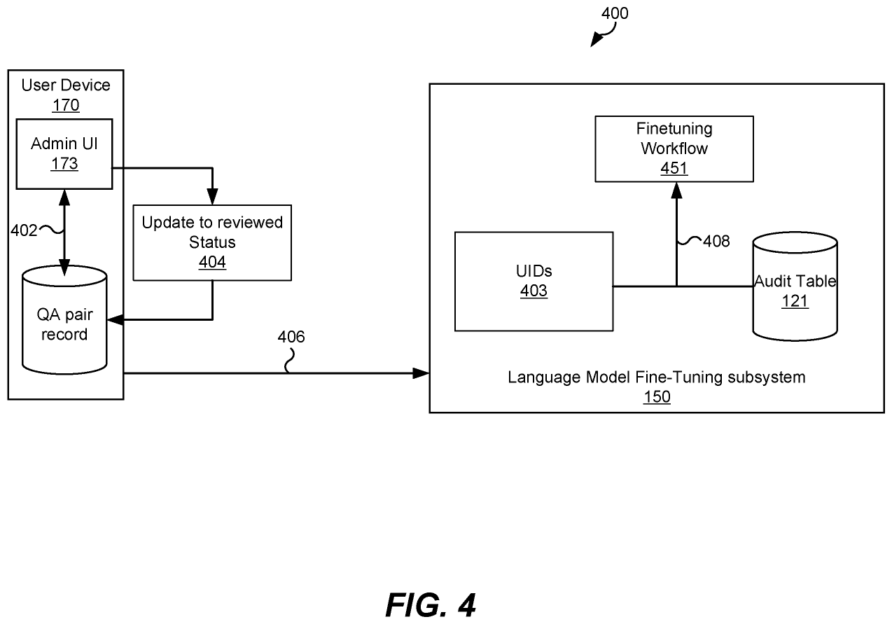

The audit table 121 is a datastore that stores QnA pairs and their corresponding UID (such as a UID 403 illustrated in FIG. 4). For example, each QnA pair may be stored in association with a corresponding UID that uniquely identifies the QnA pair. In particular, the UID may uniquely identify the question in the QnA pair. In some examples, all QnA pairs for questions that have been answered may be stored. In some examples, only some of the QnA pairs (such as those flagged for HITL review) may be stored.

The gold QnA pairs datastore 131 is a datastore that stores gold QnA pairs. A gold QnA pair is a gold question and/or a gold answer that was previously prepared by a subject matter expert. A gold QnA pair may be considered a gold standard, or best way to answer a given question that matches the gold question in the gold QnA pair.

The source documents datastore 141 is a datastore that stores source documents that may be searched to provide an answer to a question. Source documents may include web-based documents (such as HyperText Markup Language documents), Word processing documents, ASCII text documents, spreadsheets, and/or other types of content that includes text. The text may include structured text and/or unstructured text. In some examples, the source documents may change or be modified over time. For example, source documents may be added, removed, or modified. In particular examples, the source documents may include software guides or other user guides, frequently asked questions, and/or other documentation that includes text. The source documents may include content other than text, such as images and audio. Changes to the source documents datastore 141, such as additions, deletions, and/or modifications to source documents may cause answers to questions to change. For example, a software revision change may result in a corresponding change to a software guide, in which case the answer to a user's question relating to using the software can change from one version to the next.

The language model 151 is a pretrained model that is trained to understand text, including unstructured natural language text. The language model 151 may include an LLM that is pretrained on a large corpus of training data and is further fine-tuned by the computer system 110. Examples of LLMs include BERT, DistilBERT, T5, GPT-family of LLMs, LLAMA, MISTRAL, and FALCON, among others.

The computer system 110 may include one or more computing devices that execute deflection logic for fine-tuning language models. The one or more computing devices of the computer system 110 may each include a processor 112, a memory 114, a moderation subsystem 120, a search subsystem 130, a RAG subsystem 140, a language model (LM) fine-tuning subsystem 150, an answer evaluation subsystem 160, and/or other components.

One or more of the moderation subsystem 120, the search subsystem 130, the RAG subsystem 140, and the LM fine-tuning subsystem 150 may be implemented as instructions that program the processor 112. Alternatively, or additionally, one or more of the moderation subsystem 120, the search subsystem 130, the RAG subsystem 140, the LM fine-tuning subsystem 150, and the answer evaluation subsystem 160 may be implemented in hardware.

The moderation subsystem 120 is a system that determines whether or not a question and answer (QnA) pair should be used as a candidate for HITL labeling to fine-tune a language model 151, such as an LLM. The moderation subsystem 120 may filter out various types of inputs to reduce the number of QnAs for HITL review, such as personally identifiable information (PII), irrelevant questions, attempts to bypass security measures (e.g., jailbreak attempts, prompt injection attacks), queries that trigger predefined system responses, and/or other filters. Through moderation and prompt engineering for language models to further review relevant content, the moderation subsystem 120 may ensure that only relevant QnA pairs undergo HITL review.

In some examples, the moderation subsystem 120 may execute deflection logic to filter questions and/or QnA pairs for generating candidate training data used to fine-tune language models. The deflection logic may include trusted user deflection 122 that filters based on user role (trusted user status) of a user that posed the question, relevance deflection 124 that filters based on relevance of the question to a domain of interest, gold QnA deflection 126 that filters based on whether or not the question is the same as a gold question from among gold QnA pairs, and uniqueness deflection 128 that filters based on whether or not the question is a repeated question with a repeated answer. Based on execution of some or all of this deflection logic, the moderation subsystem 120 may reduce the number of candidate QnA pairs for HITL review/annotation.

### Trusted User Deflection

Trusted user deflection 122 may filter a question based on whether or not the question is from a trusted user. A trusted user is a user that is associated with a trusted status such as being identified as a subject matter expert and/or other user role. To make this determination, the method 200 may include accessing a user role from the trusted users datastore 111. Users with certain user roles indicating a trusted status will be considered a trusted user. If the question is received from a trusted user, the method 200 may proceed to 203, where the QnA pair is not considered for HITL review. In other words, at 203, the QnA pair may be filtered out and not be considered for HITL review. If the question is not received from a trusted user, the method 200 may proceed to 206.

Relevance and/or Fact-Checking Decisioning

Relevance deflection 124 may filter a question based on whether or not the question is relevant to fine-tuning the language model 151. A question may be relevant to fine-tuning the language model 151 when the question relates to a domain of interest and/or requires fact checking by an SME during HITL annotation. For example, the computer system 110 may be responsible for answering questions relating to a domain of interest that includes a software system. If the question relates to a software capability of the software system, then the question is relevant to a domain of interest for which the computer system 110 is responsible. In this case, an SME, Gold QnA pairs datastore 131, and/or source documents datastore 141 may have an answer to the question. On the other hand, a question such as “what is the weather forecast” is not relevant to the domain of interest and can therefore be filtered out of consideration for fine-tuning the language model 151. In some examples, to determine whether the question relates to a domain of interest, relevance deflection 124 may include providing the language model 151 with one or more domains of interest for which the computer system 110 is responsible, the question, and an instruction (such as a prompt) to indicate whether or not the question relates to the one or more domains of interest.

Alternatively, or additionally, relevance deflection 124 may conduct a semantic search between the question and the domains of interest. For example, relevance deflection 124 may vectorize the question and strings describing the domains of interest, then determine a level of semantic similarity, similar to the manner in which a semantic query is executed between a question and gold questions described herein.

A question requires fact-checking by the SME when a response to a question requires the knowledge of an SME, Gold QnA pairs datastore 131, and/or source documents datastore 141. For example, oftentimes, a question may be a request to reformat or re-explain a prior answer, in which case the language model 151 may not need knowledge from a SME Gold QnA pairs datastore 131, and/or source documents datastore 141 to respond to the question. In this case, relevance deflection 124 may determine that the question does not require fact checking by an SME during HITL annotation.

### Gold QnA Deflection

Gold QnA deflection 126 may filter a question based on whether or not the question is the same as a gold question from among gold QnA pairs stored in the gold QnA pairs datastore 131. Because the gold QnA pairs are question and answer pairs curated by SMEs, these pairs would not be needed to fine-tune the language model 151 to generate accurate responses because they are already considered to be accurate. Thus, gold QnA deflection 126 may filter out an input question that is the same as a gold question from a gold QnA pair. To determine whether the question matches a gold question, gold QnA deflection 126 may compare the question to gold questions in the Gold QnA Pairs datastore 131. The comparison may be based on a keyword search and/or a semantic search. For keyword search examples, gold QnA deflection 126 may use the search subsystem 130 to query one or more keywords against the gold QnA pairs datastore 131. For semantic search, gold QnA deflection 126 may use the search subsystem 130 to determine semantic similarity between the query and gold questions in the gold QnA pairs datastore 131. For example, the questions and/or answers in the gold QnA pairs datastore 131 may have been previously vectorized by the search subsystem 130. The search subsystem 130 may also vectorize the query to be compared in the same vector space and determine semantic similarity between the question and one or more gold questions based on vector similarity.

### Keyword and Semantic Search

The search subsystem 130 may search for matches between a first string of characters and a second string of characters. The matches may be based on keyword matches and/or semantic matches. Keyword matches may be exact or fuzzy matches. In a keyword search, one or more words or phrases from the query may be literally searched against the Gold QnA Pairs datastore 131. Matching keywords may indicate that the question is a gold question. Sometimes keyword searches may result in false positives or negatives. As such, the search subsystem 130 may alternatively, or additionally, include a semantic search.

In semantic search, the context, meaning, and/or intent of a query is compared to the context, meaning, and/or intent of the data to be searched. Unlike traditional keyword-based search, which may rely on exact word matches, semantic search may return results even if exact words used in the search do not appear in the data to be searched.

To perform a semantic search between two strings (such as an input query and a gold query), the search subsystem 130 may tokenize each string into tokens (such as individual words), convert them to lowercase, remove punctuation, and potentially perform stemming or lemmatization (reducing words to their root form). For example, the search subsystem 130 may generate a set of question tokens and a set of gold question tokens.

The search subsystem 130 may generate a vector based on each of the sets of tokens. For example, the search subsystem 130 may generate a question vector based on the question tokens and a gold question vector. It should be noted that the gold question vectors may be pre-computed and stored in the gold QnA pairs datastore 131. Each vector may exist within a vector space. The dimensionality of the vector space will therefore vary based on the type of vectorization. The position of vectors in the vector space may be indicative of their similarity. For example, vectors that are closer to one another in the vector space are more similar to one another than vectors that are further from one another in the vector space. The similarity between two or more vectors may therefore be determined based on their respective positions in the vector space. Thus, the level of similarity between a question vector and a gold question vector in the vector space may indicate their level of semantic similarity to one another.

In some examples, the search subsystem 130 may generate vectors from strings based on word embeddings. Word embeddings represent words in strings as dense vectors, capturing semantic meaning and relationships between words. The word vectors may be arranged in a high-dimensional space in which the distance and direction between vectors reflect semantic similarity. Word embeddings may be more useful for when strings include natural language text strings to capture their semantic context. To generate word embeddings, the search subsystem 130 may use WORD2VEC, GLOVE, and/or other techniques to generate word embeddings.

In some examples, the search subsystem 130 may generate vectors from strings based on the Term Frequency-Inverse Document Frequency (TF-IDF). TF-IDF measures the importance of words in a string relative to a larger dataset. In these examples, the computer system 110 may determine the relative importance of words in the query string against the words in a corpus of text, such as the gold QnA pairs datastore 131 or other corpus of text. Strings that share more words will result in their corresponding vectors being closer to one another in the vector space than records that share less words.

In some examples, the search subsystem 130 may generate vectors from strings based on sentence embeddings. Like word embeddings, sentence embeddings may be more useful for when data records include natural language text strings to capture their semantic context. To generate word embeddings, the search subsystem 130 may use BERT, Sentence-BERT, Universal Sentence Encoder, and/or other sentence embedding algorithms.

To determine similarity between vectors, the search subsystem 130 may perform vector similarity matching. Vector similarity matching is a mathematical comparison of the values in vectors being compared. Examples of vector similarity include cosine similarity and Euclidean distance. A result of vector similarity matching may be a semantic similarity score. The search subsystem 130 may compare the semantic similarity score between a question and a gold question against a threshold semantic similarity, which may be predefined. One example of a threshold semantic similarity based on cosine similarity is 0.8. That is, scores above 0.8 may be considered a semantic match, in which case the gold QnA deflection 126 considers the question to be semantically the same as a gold question, and therefore may filter out the question. Other predefined threshold semantic similarity values may be used and may be configured as appropriate (to reduce or decrease stringency).

Although described in the context of comparing a query against the gold QnA pairs, the search subsystem 130 may be used by the computer system 110 to compare strings in various ways. For example, in some examples, the search subsystem 130 may be used to determine whether a query matches a previously asked query, which may be stored in the audit table 121. In some examples, the search subsystem 130 may be used to determine whether an answer to the question is the same as a previous answer in the audit table 121.

### Uniqueness Deflection

Uniqueness deflection 128 may filter a question based on whether or not the question has been previously asked and answered. For example, uniqueness deflection 128 may determine whether the question is a repeated question with a repeated answer. If the question is not a repeated question, and has passed other deflection logic, then the question may be a candidate for HITL review for fine-tuning the language model 151. If the question is a repeated question (is the same as a previously asked question), uniqueness deflection 128 may determine whether a prior answer to the previously asked question is the same as a current answer to the repeated question. This is because the current answer may have changed since the previously asked question was answered. For example, if the previous answer was based on a document that has since been updated such that a different (such as a new or more detailed) answer is available, then the repeated question has a new answer such that the repeated question and new answer pair is new and is considered a candidate for HITL review.

To determine whether the question is a repeated question, uniqueness deflection 128 may use the search subsystem 130 to compare the question to previously asked questions, which may be stored in the audit table 121. The comparison may be a keyword search and/or semantic search, similar to the manner in which a question is compared to gold QnA questions. If the question does not match (whether keyword and/or semantically above a threshold semantic similarity) a previously asked question in the audit table 121, then uniqueness deflection 128 may not filter out the question. If the question does not match (whether keyword and/or semantically above a threshold semantic similarity) a previously asked question in the audit table 121, then uniqueness deflection 128 may determine that the question was previously asked.

Uniqueness deflection 128 may determine whether an answer, determined by the RAG subsystem 140 described herein, to the question is the same as the answer to the previously asked question in the audit table 121. For example, uniqueness deflection 128 may use the search subsystem 130 to compare the answer to the previously asked answers based on keyword and/or semantic searches, similar to the manner in which the question is compared to previously asked questions.

The RAG subsystem 140 is a language model retrieval system that generates answers to questions executing a language model 151 to answer a question augmented by information from a data source that is external to the language model 151. For example, the RAG subsystem 140 may use the question to identify relevant information from the source documents datastore 141. To identify content relevant information, the RAG subsystem 140 may execute the search subsystem 130 to perform keyword and/or semantic searches of the source documents datastore 141 based on the question. The RAG subsystem 140 may generate an input to the language model 151 (such as a prompt for an LLM) based on the question and the relevant information.

The language model fine-tuning subsystem 150 may adapt a pre-trained language model, such as the language model 151, to answer questions, which may be domain-specific, based on QnA pairs in the audit table 121 that have been annotated during HITL review. An annotated QnA pair may include a question and an answer to the question. Each annotated QnA pair may further include metadata such as the information source, domain-specific contextual information, and/or other data such as one or more fields stored in the audit table 121.

The annotated QnA pairs may be considered an ideal set of questions and responses, which may be used to fine-tune the language model 151 to provide more accurate responses to questions. Fine-tuning refines the ability of the language model 151 to generate accurate and contextually appropriate responses based on the annotated QnA pairs.

To fine-tune the language model 151, the language model fine-tuning subsystem 150 may prepare the annotated QnA pairs for training. For example, the language model fine-tuning subsystem 150 may vectorize the annotated QnA pairs for fine-tuning. During fine-tuning, some or all model parameters are modified guided by, and learned from, the annotated QnA pairs.

Examples of fine-tuning may include instruction tuning, full fine-tuning, and low-rank adaptation tuning. In instruction tuning, the language model 151 is trained to generate responses using QnA instructions. In full fine-tuning, all model weights are modified. In low-rank adaptation, only a subset of parameters are modified, resulting in faster and less computationally intensive training than full fine-tuning, but with potentially lower quality results.

Whichever fine-tuning (parameter-weighting technique) is used, the language model fine-tuning subsystem 150 may train the language model 151 based on supervised learning. Fine-tuning with supervised learning may use a loss function to minimize the difference between an answer the language model 151 generates in response to a question in the annotated QnA pairs and the actual answer in the annotated QnA pairs. For example, the language model fine-tuning subsystem 150 may use a cross-entropy, mean-squared error, negative log-likelihood loss, and/or other loss functions.

### Answer Re-Evaluation

Answers to questions in the computer system 110, whether by human SMEs or the fine-tuned language model 151 may be assessed to indicate how well the answer responds to the question. For example, the answer evaluation subsystem 160 may generate an efficacy score for each answer. The efficacy score may indicate how well the answer technically responded to the question, such as by including information sought by the question.

However, human-generated answers may be technically correct, but oftentimes can be poorly written. This can lead to inflated efficacy scores because the answers may technically be correct, but they are not presented in a clear, concise, or effective way. When evaluating the performance of a model, efficacy scores are often used to assess the accuracy or correctness of the answers. Poorly written answers that are still technically correct could still score highly, even though the quality of the response itself could be suboptimal. This may be because the evaluation process failed to take into account the quality of the answer (rather than just its technical response), leading to incorrect assumptions about the performance of the language model 151. This problem was identified when it became clear that the language model 151 failed to improve correctness, but instead, low-quality answers were still receiving high efficacy scores because they were technically accurate but poorly written.

To address these issues, the answer evaluation subsystem 160 may reevaluate efficacy scores based on use of a large language model (which may be the same as or different from the fine-tuned language model 151) to generate answers to questions. Human reviewers may also edit the generated answers to ensure they are not only correct but also written in a clear and coherent manner. In some examples, the LLM may act as a judge to assess the quality of the answer, helping to ensure that the answers are both factually accurate and well-written. For example, the LLM may be provided with a prompt that includes the question, an answer to the question, and an instruction to assess whether the answer is factually accurate and well-written. In some of these examples, the LLM may access the source documents datastore 141 and/or other information to assess the correctness of the answer and use its pre-trained knowledge of language to assess whether the answer was well-written.

In some examples, to further improve answers, the process of creating QnA pairs was adjusted to focus more on improving the content quality of the answers. Rather than simply relying on correctness (e.g., the model generating the correct answer), the focus shifted to how well the answer is written and whether it provides clear and concise information. This change aims to avoid skewing the efficacy scores and ensures that a poorly written but correct answer doesn't receive a higher efficacy score than it should.

The main goal is to improve the quality of the training data. In the context of LLM fine-tuning, better-quality Q&A pairs lead to more effective training, which ultimately produces a more accurate and capable model. The improvement in training data quality ensures that efficacy scores accurately reflect the true performance of the system. This means that high efficacy should indicate not only correctness but also clarity and quality of the response.

The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

A user device 170 is a computer device that a user uses to interact with the computer system 110. The user device 170 may include a QnA application 171 that a user can use to ask questions and receive answers and an admin user interface (UI) 173 that an SME user may use to review questions and/or QnA pairs during HITL review. Although not shown, the user device 170 may include a processor and a memory, similar to the processor 112 and the memory 114.

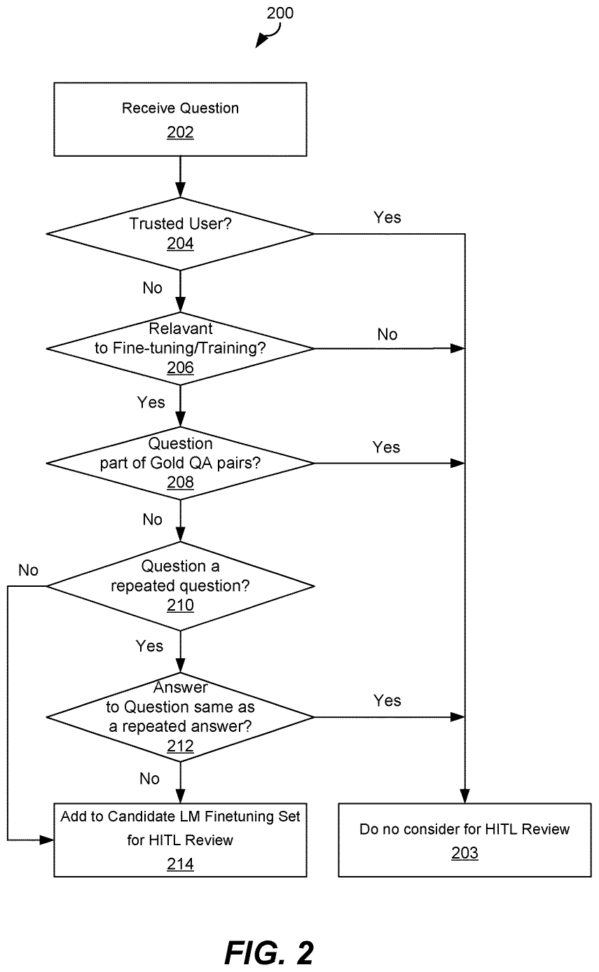

FIG. 2 illustrates an example of a method 200 of deflection logic for HITL curation of QnA pairs for fine-tuning language models such as LLMs. The method 200 may be performed by the computer system 110.

At 202, the method 200 may include receiving a question for which an answer is to be retrieved by the computer system 110. The question may be received from a user device 170 via the search API 105. In some examples, the question may relate to a domain of interest for which the computer system 110 provides answers. For example, the domain of interest may include payment network systems and services, computer networks, merchant services, and/or other domains of interest for which users may pose questions.

At 204, the method 200 may include determining whether the question is received from a trusted user. A trusted user is a user that is associated with a trusted status such as being identified as a subject matter expert and/or other user role. To make this determination, the method 200 may include accessing a user role from the trusted users datastore 111. Users with certain user roles indicating a trusted status will be considered a trusted user. If the question is received from a trusted user, the method 200 may proceed to 203, where the QnA pair is not considered for HITL review. In other words, at 203, the QnA pair may be filtered out and not be considered for HITL review. If the question is not received from a trusted user, the method 200 may proceed to 206.

At 206, the method 200 may include determining whether the question is relevant to fine-tuning the language model 151. At 208, if the question is not relevant to fine-tuning the language model 151, then the method 200 may not consider the question for HITL review at 203. If the question is relevant to fine-tuning the language model 151, then the method 200 may proceed to 208.

At 208, the method 200 may include determining whether the question is a gold question from among Gold QnA Pairs stored in the Gold QnA Pairs datastore 131. If the question matches a gold question, then the question is not considered a candidate for HITL annotation at 203. To determine whether the question matches a gold question, the method 200 may compare the question to gold questions in the Gold QnA Pairs datastore 131. The comparison may be based on a keyword search and/or a semantic search.

If the question is not a gold question (does not patch a question in a gold QnA pair), the method 200 may proceed to 210. At 210, the method 200 may include determining whether the question is a repeated question. If the question is not a repeated question, then the method 200 may proceed to 214. At 214, the method 200 may include adding the question (and, if available, an answer to the question) as a candidate language model finetuning set for HITL review.

Returning to 210, if the question is a repeated question, the method 200 may proceed to 212. At 212, the method 200 may include determining whether an answer to the question matches a repeated answer. If yes, the method 200 may not consider the question for HITL review. If the answer does not match an answer to the repeated question, the method 200 may proceed to 214, where the question and its answer is added to the candidate language model finetuning set for HITL review.

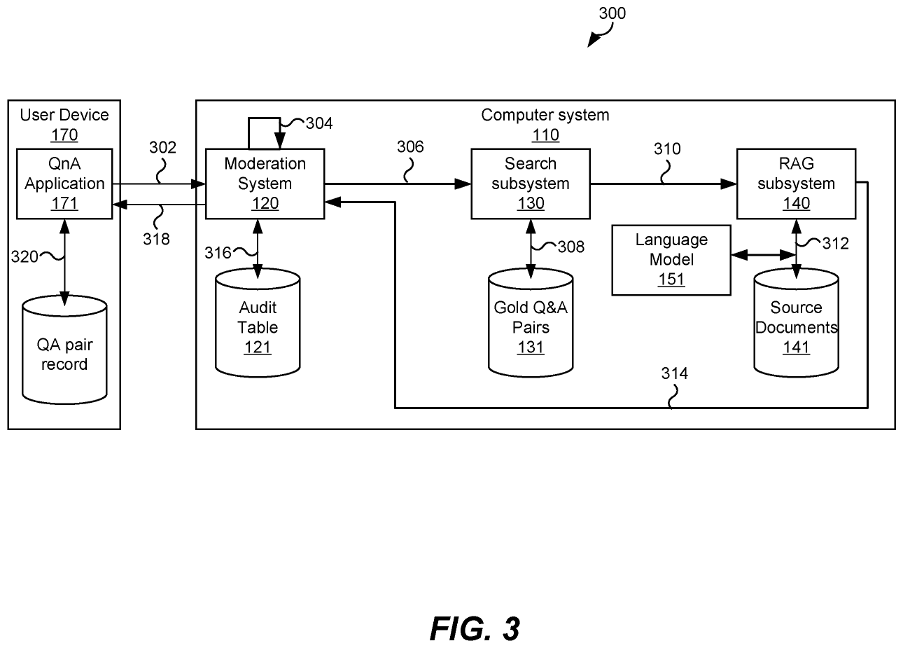

FIG. 3 illustrates an example of a data flow 300 of deflection logic for HITL curation of QnA pairs for fine-tuning language models. FIG. 3 will refer to one or more features described with respect to FIG. 1 for clarity and brevity.

At 302, the QnA application 171 sends a question to the computer system 110. For example, the QnA application 171 may make an API call to the search API 105 illustrated in FIG. 1. The moderation subsystem 120 may receive the query for generating an answer to the question and considering the question for HITL review. The question is assigned with a unique identifier (UID) to track its lifecycle through processing by the computer system 110. The UID may be generated by the QnA application 171 or by the computer system 110. In some examples, the moderation subsystem 120 may process the question through deflection logic described at FIG. 1. The moderation subsystem 120 may collect results of the deflection logic processing, and store some or all of the collected results in association with the UID and/or the question. Fore example, for each QnA pair, the moderation subsystem 120 may generate a QnA pair record that includes the UID that identifies the question (and/or the QnA pair), a result of trusted user deflection 122, relevance deflection 124, gold QnA deflection 126, and uniqueness deflection 128.

At 304, the moderation subsystem 120 may filter out questions that need not be further considered for HITL review. For example, the moderation subsystem 120 may perform trusted user deflection 122 and/or relevance deflection 124 and store the results in the QnA pair record.

At 306, the moderation subsystem 120 may execute gold QnA deflection 126 and store the results in the QnA pair record. For example, at 308, the moderation subsystem 120 may execute the search subsystem 130 to conduct a keyword and/or search subsystem 130 on the gold QnA pairs datastore 131. If the question matches a gold question based on the search, the moderation subsystem 120 may filter out (not consider) the question for HITL review. If the question does not match a gold question based on the search, the moderation subsystem 120 may continue to consider the question (and its answer) for HITL review subject to other deflection logic.

At 310, the moderation subsystem 120 may execute the RAG subsystem 140 to obtain relevant content from the source documents datastore 141. At 312, the RAG subsystem 140 may use a language model 151 to obtain the relevant content. In some examples, the RAG subsystem 140 obtains the top N relevant content, in which N is an integer. In some examples, the N is 5, although other values may be used. At 314, the RAG subsystem 140 may provide the question and relevant content (such as the top N relevant content) to the moderation subsystem 120.

At 316, the moderation subsystem 120 may perform store the QnA pair record in the audit table 121. An example of a QnA pair record after processing by the moderation subsystem 120 is illustrated in Table 1.

Table 1. In the example QnA pair record, metadata fields are in key=value format in which the field UID has a value of “123”. UID “123” uniquely identifies this QnA pair. The UID may have been generated by a user device 170 or when the question is received at the computer system 110. The goldQnA field has a value of “true,” indicating that the question matched a gold question from among the gold QnA pairs. The moderationPass field has a value of “true,” indicating that the question has passed moderation review, such as relevance deflection 124. The reviewed field Has a value of “false”, indicating that the QnA pair identified by UID 123 has not been HITL-reviewed (has not been annotated by a SME, for example). The reviewed field will be changed to “true” after HITL review. Other deflection logic results and other fields may be included as well, or instead.

```
{
  UID = 123,
  goldQnA = true,
  isTrustedUser = true,
  moderationPass = true,
  reviewed = false.
}
```

The moderation subsystem 120 may further filter the question based on PII checking and governance checking.

At 318, the moderation subsystem 120 may transmit the QnA pair and/or the QnA pair record to the user device 170. At 320, the user device 170 may store the QnA pair and/or the QnA pair record in its internal storage to identify candidate QnA pairs to fine-tune a language model 151.

FIG. 4 illustrates an example of a data flow 400 of fine-tuning a language model (such as language model 151) based on annotated QnA pairs.

At 402, the Admin UI 173 may retrieve and display QnA pairs that have not been filtered out by the deflection logic 101 for HITL review. For example, the admin UI 173 may retrieve QnA pair records that indicate that a corresponding QnA pair: is not flagged as a question asked by a trusted user; is not a gold question and/or response; has passed moderation checks (such as relevance and PII checks); and has not been reviewed. The admin UI 173 may display these QnA pairs for HITL review. For example, the SME may annotate the answer to more appropriately respond to the question in the QnA pair. In some examples, the SME may annotate the question as well. Annotation may include adding or removing words, changing an order of words, and/or otherwise modifying the content of an annotated item (such as an answer and/or question).

At 404, the admin UI 173 may update each annotated QnA pair record to indicate that the pair has been reviewed. For example, the admin UI 173 may update the corresponding QnA pair record's “reviewed” field to “true.”

At 406, the admin UI 173 may transmit annotated QnAs for fine-tuning the language model 151. For example, the admin UI 173 may generate batch records that include a plurality of annotated QnAs and periodically transmit the batch records for storage at the audit table 121 or other location accessible to the language model fine-tuning subsystem 150. In some examples, the admin UI 173 may transmit annotated QnAs as they are completed. In some examples, the admin UI 173 may transmit annotated QnAs directly to the language model fine-tuning subsystem 150.

At 408, the language model fine-tuning subsystem 150 may execute a fine-tuning workflow 451 for fine-tuning the language model 151. The fine-tuning workflow 451 may obtain UIDs 403 corresponding to annotated QnAs (such as from the admin UI 173). The fine-tuning workflow 451 may retrieve QnA pairs from the audit table 121 identified by the UIDs 403, using annotated answers if included in the QnA pairs. The fine-tuning workflow 451 may then fine-tune the language model 151 based on the retrieved and annotated QnA pairs, such as described in FIG. 1.

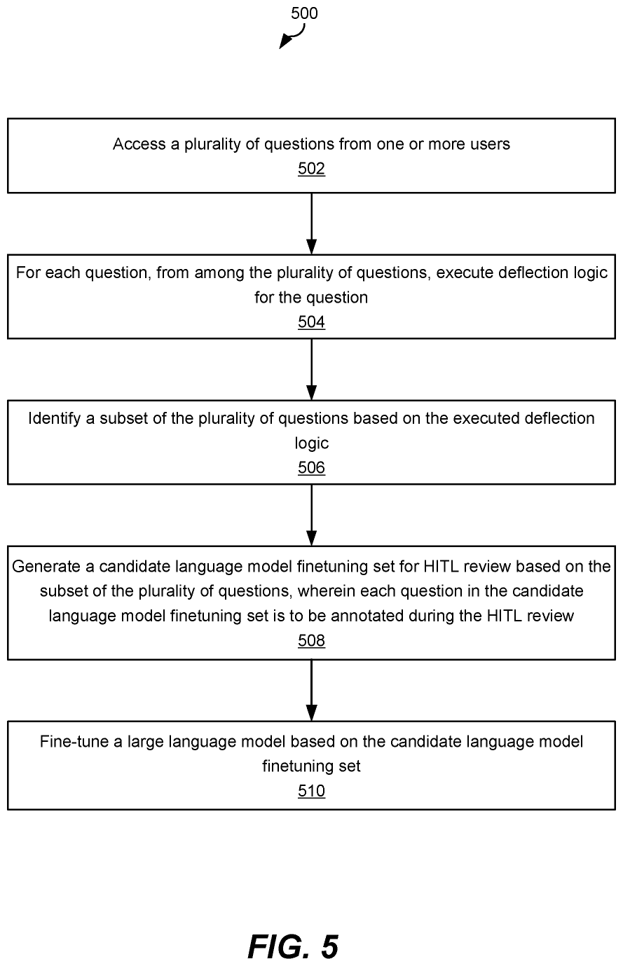

FIG. 5 illustrates an example of a method 500 of deflection for generating QnA pairs for fine tuning a language model. At 502, the method 500 may include access a plurality of questions from one or more users.

At 504, for each question, from among the plurality of questions, the method 500 may include executing deflection logic (such as deflection logic 101) comprising: trusted user deflection (such as trusted user deflection 122) that determines whether or not a user that posed the question is a trusted user, relevance deflection (such as relevance deflection 124) that determines whether or not the question is relevant to an information domain from among the plurality of information domains, gold Question and Answer (QnA) pair deflection (such as gold QnA deflection 126) that determines whether or not the question matches a question from a curated set of gold QnA pairs, and/or uniqueness deflection (such as uniqueness deflection 128) that determines whether or not the question was previously asked and answered. The deflection logic may include one, two, three, or four of the trusted user deflection, relevance deflection, gold QnA deflection, and uniqueness deflection. In other words, the deflection logic may include the trusted user deflection, relevance deflection, gold QnA deflection, and/or uniqueness deflection.

At 506, the method 500 may include identifying a subset of the plurality of questions based on the executed deflection logic. For example, the plurality of questions may be filtered so that at least one question from among the plurality questions is not in the subset.

At 508, the method 500 may include generating a candidate language model finetuning set (such as the set described at 214 of FIG. 2) for HITL review based on the subset of the plurality of questions. Each question in the candidate language model finetuning set is to be annotated during the HITL review.

At 510, the method 500 may include fine-tuning a large language model (such as the language model 151) based on the candidate language model finetuning set.

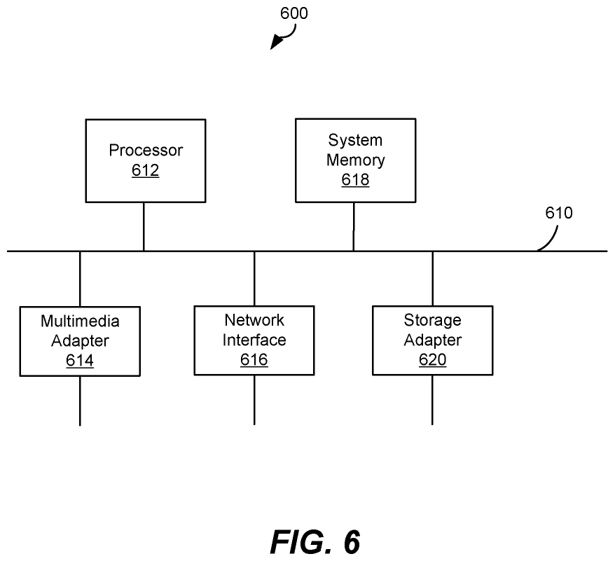

FIG. 6 illustrates an example of a computer system 600 that may be implemented by devices illustrated in FIG. 1. The computer system 600 may be part of or include the system environment 100 to perform the functions and features described herein. For example, various ones of the devices of system environment 100 may be implemented based on some or all of the computer system 600. The computer system 600 may include, among other things, an interconnect 610, a processor 612, a multimedia adapter 614, a network interface 616, a system memory 618, and a storage adapter 620.

The interconnect 610 may interconnect various subsystems, elements, and/or components of the computer system 600. As shown, the interconnect 610 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 610 may allow data communication between the processor 612 and system memory 618, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 612 may control operations of the computer system 600. In some examples, the processor 612 may do so by executing instructions such as software or firmware stored in system memory 618 or other data via the storage adapter 620. In some examples, the processor 612 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 616 may provide the computer system 600 with an ability to communicate with a variety of remote devices over a network. The network interface 616 may include, for example, an Ethernet adapter, a Fibre Channel adapter, and/or other wired- or wireless-enabled adapter. The network interface 616 may provide a direct or indirect connection from one network element to another, and facilitate communication to and between various network elements. The storage adapter 620 may connect to a standard computer readable medium for storage and/or retrieval of information, such as a fixed disk drive (internal or external).

Other devices, components, elements, or subsystems (not illustrated) may be connected in a similar manner to the interconnect 610 or via a network. The devices and subsystems can be interconnected in different ways from that shown in FIG. 6. Instructions to implement various examples and implementations described herein may be stored in computer-readable storage media such as one or more of system memory 618 or other storage. Instructions to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

The term “based on” means based at least in part on. In the Figures, the use of the letter “N” to denote plurality in reference symbols is not intended to refer to a particular number. For example, “170A-N” does not refer to a particular number of instances of 170A-N, but rather “two or more.”

The databases (such as 111, 121, 131, 141, and similar databases, which may store model features, parameters, hyperparameters, and/or other data related to training or executing the language model 151) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
access a plurality of questions from one or more users;
for each question, from among the plurality of questions:
execute deflection logic comprising: trusted user deflection that determines whether or not a user that posed the question is a trusted user, relevance deflection that determines whether or not the question is relevant to an information domain from among the plurality of information domains, gold Question and Answer (QnA) pair deflection that determines whether or not the question matches a question from a curated set of gold QnA pairs, and/or uniqueness deflection that determines whether or not the question was previously asked and answered;
identify a subset of the plurality of questions based on the executed deflection logic;
generate a candidate language model finetuning set for Human-In-The-Loop (HITL) review based on the subset of the plurality of questions, wherein each question in the candidate language model finetuning set is to be annotated during the HITL review; and
fine-tune a large language model based on the candidate language model finetuning set.

2. The system of claim 1, wherein to execute the trusted user deflection for each question, the processor is programmed to:
access a user role associated with a user posed the question;
determine whether or not the user role is associated with a trusted role; and
filter the question based on the determination of whether or not the user role is associated with a trusted role.

3. The system of claim 1, wherein to execute the relevance deflection for each question, the processor is programmed to:
determine whether or not the question is relevant to one or more of the plurality of information domains; and
filter the question based on the determination of whether or not the question is relevant to one or more of the plurality of information domains.

4. The system of claim 1, wherein to execute the gold QnA pair deflection for each question, the processor is programmed to:
compare the question and each gold question from among a plurality of gold QnA pairs; and
filter the question based on the comparison.

5. The system of claim 4, wherein to compare the question and each gold question, the processor is programmed to:
generate a semantic comparison between the question and each gold question, wherein each semantic comparison indicates a level of semantic similarity between the question and a gold question.

6. The system of claim 1, wherein to execute the uniqueness deflection for each question, the processor is programmed to:
compare the question to previously asked questions; and
filter the question based on the comparison so that the question is not filtered out if the question does not match a previously asked question.

7. The system of claim 6, wherein the processor is further programmed to:
determine that the question matches a previously asked question;
access an answer generated for the question and a previous answer generated for previously asked question; and
compare the answer with the previous answer, wherein the question is filtered based on the comparison of the answer with the previous answer.

8. The system of claim 7, wherein the answer generated for the question is based on a language model that is prompted with the question and content from one or more source documents and outputs the answer based on the question and the content from one or more source documents.

9. The system of claim 1, wherein to fine-tune the language model, the processor is further programmed to:
access at least one QnA pair that has been annotated during HITL review after having been processed based on the deflection logic;
fine-tune the language model based on the at least one QnA pair.

10. The system of claim 1, wherein the processor is further programmed to:
re-evaluate one or more answers generated by the fine-tuned language model based on a language model judge.

11. A method, comprising:
accessing a plurality of questions from one or more users;
for each question, from among the plurality of questions:
executing deflection logic comprising: trusted user deflection that determines whether or not a user that posed the question is a trusted user, relevance deflection that determines whether or not the question is relevant to an information domain from among the plurality of information domains, gold Question and Answer (QnA) pair deflection that determines whether or not the question matches a question from a curated set of gold QnA pairs, and/or uniqueness deflection that determines whether or not the question was previously asked and answered;
identifying a subset of the plurality of questions based on the executed deflection logic;
generating a candidate language model finetuning set for Human-In-The-Loop (HITL) review based on the subset of the plurality of questions, wherein each question in the candidate language model finetuning set is to be annotated during the HITL review; and
fine-tuning a large language model based on the candidate language model finetuning set.

12. The method of claim 11, wherein executing the trusted user deflection for each question, comprises:
accessing a user role associated with a user posed the question;
determining whether or not the user role is associated with a trusted role; and
filtering the question based on the determination of whether or not the user role is associated with a trusted role.

13. The method of claim 11, wherein executing the relevance deflection for each question, comprises:
determining whether or not the question is relevant to one or more of the plurality of information domains; and
filtering the question based on the determination of whether or not the question is relevant to one or more of the plurality of information domains.

14. The method of claim 11, wherein executing the gold QnA pair deflection for each question comprises
comparing the question and each gold question from among a plurality of gold QnA pairs; and
filtering the question based on the comparison.

15. The method of claim 14, wherein comparing the question and each gold question comprises:
generating a semantic comparison between the question and each gold question, wherein each semantic comparison indicates a level of semantic similarity between the question and a gold question.

16. The method of claim 11, wherein executing the uniqueness deflection for each question comprises:
comparing the question to previously asked questions; and
filtering the question based on the comparison so that the question is not filtered out if the question does not match a previously asked question.

17. The method of claim 16, further comprising:
determining that the question matches a previously asked question;
accessing an answer generated for the question and a previous answer generated for previously asked question; and
comparing the answer with the previous answer, wherein the question is filtered based on the comparison of the answer with the previous answer.

18. The method of claim 11, wherein fine-tuning the language model comprises:
accessing at least one QnA pair that has been annotated during HITL review after having been processed based on the deflection logic;
fine-tuning the language model based on the at least one QnA pair.

19. The method of claim 11, further comprising:
re-evaluating or more answers generated by the fine-tuned language model based on a language model judge.

20. A non-transitory computer readable medium that stores instructions that, when executed by a processor, programs the processor to:
access a plurality of questions from one or more users;
for each question, from among the plurality of questions:
execute deflection logic comprising: trusted user deflection that determines whether or not a user that posed the question is a trusted user, relevance deflection that determines whether or not the question is relevant to an information domain from among the plurality of information domains, gold Question and Answer (QnA) pair deflection that determines whether or not the question matches a question from a curated set of gold QnA pairs, and/or uniqueness deflection that determines whether or not the question was previously asked and answered;
identify a subset of the plurality of questions based on the executed deflection logic;
generate a candidate language model finetuning set for Human-In-The-Loop (HITL) review based on the subset of the plurality of questions, wherein each question in the candidate language model finetuning set is to be annotated during the HITL review; and
fine-tune a large language model based on the candidate language model finetuning set.
